(19) United States
(12) Patent Application Publication
(10) Pub. No.: US 2005/0279082 A1
(43) Pub. Date: Dec. 22, 2005

(54) Hybrid rocket motor design and apparatus

(76) Inventor: Keith Eric Stormo, Moscow, ID (US)

Correspondence Address: Keith E. Stormo, 904 East D St., Moscow, ID, 83843, US

(21) Appl. No.: 11/155,551

(22) Filed: Jun. 20, 2005

Related U.S. Application Data
(60) Provisional application No. 60/580,800, filed on Jun. 18, 2004.

(51) Int. Cl. F02K 9/72

(52) U.S. Cl. 60/204; 60/251

(57) ABSTRACT

This patent is for a hybrid rocket motor that allows a regeneratively cooled nozzle and combustion chamber with very limited modifications to the construction of the rocket motor made with standard tubes and components. This allows for a very economical and efficient hybrid rocket motor for propelling rockets for both hobby and commercial uses.

### BACKGROUND OF THE INVENTION

Hybrid rocket motors have been used for some time as commercial and hobby type motors. These motors generally burn a solid fuel like HTPB, PVC or other rubber or plastic solid fuel grains with the oxidizer being usually either hydrogen peroxide (H₂O₂), liquid oxygen (LOX) or nitrous oxide (N₂O). These motors normally have one of two designs, either 1. A separate tank with a fuel grain inside a motor case attached to the tank with an automatic or pyro valve keeping the oxidizer contained until firing or 2. A monotube design where there is a floating bulkhead between the fuel grain and the liquid oxidizer and a fill tube is burned off to allow the oxidizer to flow into the combustion chamber and begin the rocket fuel burning.

### DESCRIPTION OF THE DRAWINGS

FIG. 1. Cross section of one embodiment of the design.

FIG. 2. Nozzle with Spin Design

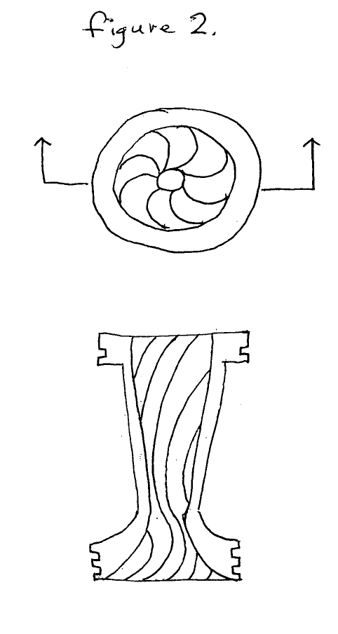

### DESCRIPTION OF THE PREFERRED EMBODIMENTS

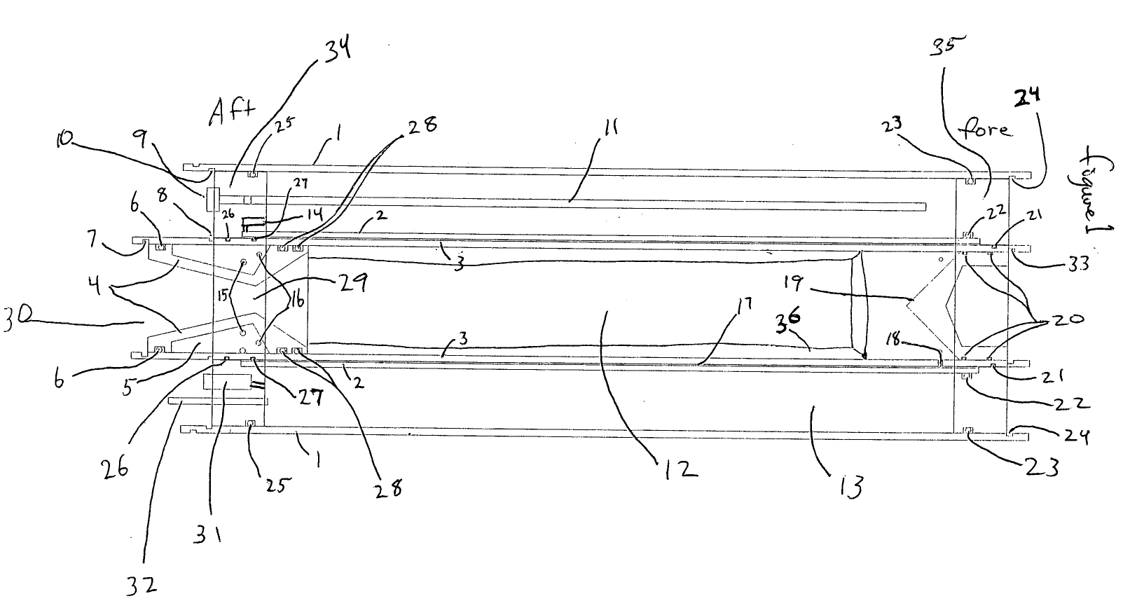

My hybrid motor consists of 3 concentric tubes with the outer tube (1) called the tank outer wall, the middle tube (2) called the regenerative cooling tube and the inner tube (3) forming the tank inner wall and the combustion chamber inside the inner tube. The snap ring groove (8) allows the control of the inner tube position and retention by using a retention screw or clip. A pressure balanced shuttle valve (19) seals the oxidizer ports (18) when the shuttle valve is slide in to the combustion chamber until the two shuttle valve o-rings (20) are on either side of the oxidizer ports. This stops the flow of oxidizer from moving from the tank region (13) through the nozzle regenerative cooling region (5) into the combustion chamber regenerative cooling region (17) and finally into the combustion chamber (12). The FIG. 1 shows the shuttle valve in the open position. Snap ring groove (33) allows a snap ring to keep the shuttle valve from exiting the combustion chamber upon firing. Nozzle snap ring groove (7) allows the retention of the nozzle (4) in the motor as well. By calculating the depth of the snap ring grooves, controlled burst pressures can be designed to maintain safety and allow controlled failure modes. Aft bulkhead (34) has a snap ring groove (10) that allows the retention of the aft bulkhead and an O-ring grove and O-ring (25) to contain oxidizer inside the tank. The fore snap ring groove (24) keeps the fore bulkhead (35) from being forced out of the tank tube by the oxidizer pressure and the fore bulkhead O-ring (23) keeps the oxidizer from leaking out. The middle tube (2) keeps the bulkheads from sliding in towards each other. O-ring (22) keeps the seal between the fore bulkhead and the regenerative cooling tube (2). This forces the liquid path of oxidizer to go through the aft oxidizer port (14) into the regenerative cooling region. O-ring (26) keeps the oxidizer from escaping out past the bulkhead and the O-ring (27) forces the oxidizer to go through the nozzle cooling in ports (15) into the nozzle regenerative cooling region (5). The only exit for the oxidizer from the nozzle cooling region is through the nozzle cooling out ports (16). This allows the oxidizer to now pass in a thin film through the combustion chamber regenerative cooling region (17) which keeps the combustion chamber from overheating and possible failure. As the oxidizer enters the combustion chamber through port (18) the jet is deflected by the angled surface of the shuttle valve and moves in the direction of the outlet (29). This angled surface can be machined such that either spin is imparted on the deflected gases or turbulence is imparted to get better mixing of the oxidizer with the fuel surface. This increases the fuel regression rate. As the oxidizer enters the combustion chamber is allows the rapid combustion of the fuel grain (36) and rapid gas generation occurs which enters the convergent region of the nozzle (29) and exits the rocket motor through the divergent section (30) of the nozzle (4). The gas is moving very fast which then allows the rocket motor to do work and propel the rocket motor in the opposite direction. O-rings (21) and (26) seal the inner tube to the bulkheads and O-rings (6) and (28) seal the nozzle into the inner tube. Screw (9) and riser tube (11) allows the controlled release of oxidizer for venting and filling control. A tank overpressure safety device is (31) used to keep the tank from failing due to overpressure of liquid expansion without relief. Fill stem (32) has either a check valve or manual valve to allow the oxidizer tank filling and then prevent the leaking out of oxidizer after filling.

The regenerative cooling of the combustion chamber and nozzle allows the use of standard materials like aluminum and copper for combustion chambers and nozzles without weakening at higher temperatures. It also allows the increase in efficiency by preheating the oxidizer as it enters the combustion chamber. The nozzle could be a graphite or other high temperature material and then nozzle cooling would not be needed. To operate without nozzle cooling, the O-ring (27) would be left out which would allow direct flow of the oxidizer from the port (14) into the regenerative cooling region (17). The ports (15) and (16) could also be left out if the motor did not require regenerative nozzle cooling.

A unique feature is using a number of 1 mm O-rings in the assembly of the inner combustion chamber which allows a minimum of tube wall thickness for safety and not needing any excess tube wall thickness for deep O ring grooves.

Another unique feature is that by changing the angle or shape of the shuttle valve end, different types of mixing intensity can be developed inside the combustion chamber as the oxidizer enters the chamber. A problem with most current hybrid designs is that the central tube that both fills the monotube an then is the oxidizer orifice points straight into the combustion chamber so a significant oxidizer is sometimes just passing through the chamber without being used for combustion.

It is obvious that crimped, screwed or bolted retainers for the bulkheads would be possible and this invention is not limited to snap ring retainers. A key novel feature is that all of this regenerative cooling of both the nozzle and the combustion chamber can be accomplished by only the addition of a few very thin O-rings.

The clearance between the O-ring groove, the tube and the bulkhead can also be used to advantage by designing in secondary pressure relief when the O-ring squeezes out of the space between the inner tube (3) and the bulkhead (34). Tests have shown that this can be controlled to not leak below 1300 but to leak at over 1300 psi. The use of standard tube and special O-rings allows a very economical but robust and highly featured motor to be constructed. The use of the balanced shuttle valve allows the motor to be held fully loaded for some period of time without needing to vent. This is a major advantage for busy launches and also for two-stage flights.

For initiation there are many methods that have proved successful. One is a black powder charge inside the motor. Another is pyrodex charge. A preferred method is a mixture of black powder and pyrodex contained in a disposable drinking straw that is pushed up inside the motor through the nozzle. Others include a small motor pointed up into the hybrid motor, a sealed cap with compressed air to move the shuttle valve. The shuttle valve could also be moved mechanically to start the flow of oxidizer. A small initiator flame is usually used to start the combustion of the fuel and oxidizer and often this comes from the black powder or pyrodex. Steel wool and oxygen with a spark would also be a good initiation technique.

With this unique design the ability to use any of a very wide range of fuel grains is possible. Since there is no end load on the fuel grain like in most monotube motors, the fuel grain can be very soft or flexible. It can easily be layered or segmented to have different regression profiles. It also allows the use of very high specific impulse fuels like nylon since the length to diameter ration is much more favorable for slow regressing fuels like nylon. In testing I have found that black nylon has twice the regression rate as white nylon. This is a new discovery that I have discovered that allows good design of hybrid motor fuel vs regression rate and thrust and oxidizer/fuel (O/F) ratios. If the O/F ratio is too high for white nylon then change the fuel grain to a faster regressing fuel like black nylon or PVC or Rubber or HTPB or wax for a very high regression rate. Likewise the length of the fuel grain can be adjusted to optimize O/F ratios or to induce special effects like smoky motors by having an low O/F ratio.

The careful selection of certain ID and OD tubes allows good flow between the spaces, little wasted weight, and high heat transfer in the regenerative regions.

Although the descriptions of the preferred embodiments have been quite specific, it is understood that various modifications could be made without deviating from the spirit of the present invention. Accordingly, it is intended that the present invention be dictated by the appended claims rather then by the descriptions of the preferred embodiments.

1. A rocket engine comprising:
a combustion chamber defined by a wall portion and having a chamber axis, a closed end and a nozzle end, said wall portion including a movable shuttle valve end wall, a nozzle end wall and a side wall between said closed end wall and said nozzle end wall, said side wall having an inner side wall surface and outer side wall surface;
an outlet nozzle at said nozzle end;
at least one first fluid inlet opening in said wall portion for directing a first combustion component fluid into said chamber that is covered by the movable shuttle valve in the closed position but exposed to the combustion chamber when the shuttle valve is in the open position;
at least one second fluid inlet opening in said side wall for introducing cooling liquid flow to the outside wall of the nozzle and inside the inner sidewall surface but not into the combustion chamber at a point downstream from said at least one first fluid.

2. The rocket engine of claim 1 wherein first fluid openings allow the change of flow direction after impinging on the balanced shuttle valve.

3. The rocket engine of claim 2 wherein the surface of the balanced shuttle valve imparts turbulence or rotation to the incoming fluid flow.

4. The rocket engine of claim 2 wherein the surface of the balanced shuttle valve has machined curved or straight surfaces to direct the fluid flow in a desired direction.

5. The rocket engine of claim 1 wherein said combustion component fluid is an oxidizer fluid and passes through the space between the outside wall of the nozzle and the inner side wall surface of the combustion chamber tube before passing along the outer sidewall surface of the combustion chamber tube and then entering through the fluid inlet opening and impinging on the movable shuttle valve.

6. The rocket engine of claim 5 wherein the oxidizer fluid cools the nozzle and combustion chamber before entering the combustion chamber.

7. The rocket engine of claim 6 wherein a second tube inner wall surface maintains a narrow path for oxidizer fluid to pass close to the outer sidewall surface of the combustion chamber.

8. The rocket engine of claim 7 wherein a third tube comprises an oxidizer tank with the inside wall of the tank being the outer sidewall of the combustion chamber and the inside wall of the third tube and the second tube to maintain the narrow path for oxidizer fluid flow.

9. The rocket engine of claim 8 wherein tank end bulkheads maintain the correct position aof all three tubes.

10. The rocket engine of claim 1 wherein said nozzle end includes a nozzle converging portion.

11. The rocket engine of claim 1 wherein the nozzle has curved surfaces that impart rotational flow of the gasses flowing through the nozzle.

12. The rocket engine of claim 1 wherein said balanced shuttle valve can be moved to its open position by pressure in the combustion chamber.

13. The rocket engine of claim 1 wherein said balanced shuttle valve can be moved to its open position by mechanical means.

14. A rocket engine of claim 8 wherein all tubes are of standard size and o-ring groove depth and o-ring cross sectional diameter determine the proper flow of the oxidizer fluid flow.

15. The method of claim 1 including introducing a second combustion component fluid near said closed end.

16. The method of claim 1 wherein the nozzle is of a balanced design so that pressurized oxidizer fluid can be surrounding the outside of the nozzle without imparting a linear force on the nozzle.

17. The method of claim 1 wherein the shuttle valve is of a balanced design so that pressurized oxidizer fluid can be surrounding the outside of the shuttle valve without imparting a linear force on the nozzle.

18. The method of claim 8 wherein the length/diameter ratio of the rocket engine is between 4 and 6.

19. The method of claim 8 wherein the length/diameter ratio of the rocket engine is between 6 and 10.

20. The method of claim 8 wherein the length/diameter ratio of the rocket engine is between 10 and 20.
